(19) United States
(12) Patent Application Publication
(10) Pub. No.: US 2007/0165543 A1
(43) Pub. Date: Jul. 19, 2007

(54) Routing system and route update method

(76) Inventor: Hong-Don Joo, Suwon-si (KR)

Correspondence Address: Robert E. Bushnell, Suite 300, 1522 K Street, N.W., Washington, DC, 20005-1202, US

(21) Appl. No.: 11/635,672

(22) Filed: Dec. 8, 2006

(30) Foreign Application Priority Data
Jan. 19, 2006 (KR) 10-2006-0005802

(51) Int. Cl. H04L 12/28; H04L 12/56

(52) U.S. Cl. 370/254; 370/395.31; 370/408

(57) ABSTRACT

A route update method includes: storing information on route insertion sequence by each routing protocol in respective entries in a routing table; performing a prefix search according to the stored route insertion sequence upon a restart of a routing module, and updating a corresponding routing entry upon a prefix matching occurring as a result of the prefix search, and performing a search according to a general Trie structure upon a prefix matching failure to succeed occurring as a result of the prefix search. Accordingly, the route search time is reduced upon a route update.

### CLAIM OF PRIORITY

This application makes reference to, incorporates the same herein, and claims all benefits accruing under 35 U.S.C.§119 from an application for ROUTING SYSTEM AND ROUTE UPDATE METHOD earlier filed in the Korean Intellectual Property Office on the 19^{th} of Jan. 2006 and there duly assigned Serial No. 10-2006-0005802.

### BACKGROUND OF THE INVENTION

1. Field of the Invention

The present invention relates to a routing system and a route update method, and more particularly to a routing system and a route update method to perform a search according to an insertion sequence for each routing protocol before performance of a Trie search in a routing management of a Trie structure.

2. Description of the Related Art

A routing system serves to transfer packets to the next node on an optimum path up to a destination according to three-layer addresses. The routing system is composed of a plurality of line cards, a backplane, and a Central Processing Unit (CPU). The line cards physically connect different networks adopting various link technologies with a routing system. The CPU implements a routing protocol, generates and manages a routing table, and performs an interfacing with a network management system. The backplane connects the line cards with the CPU.

There are many kind of routing systems according to scale and use. Such systems, however, have a common operation as follows:

First, the line card of the routing system that has received an externally inputted packet terminates the corresponding link layer and checks on whether or not the received packet is abnormal. That is, for example, the line card checks for Cyclic Redundancy Code (CRC) in the case of Ethernet, or the combination of the received cells with packets in the case of Asynchronous Transfer Mode (ATM). Next, the routing system checks for errors for an IP header, reads a destination IP address, and performs a longest prefix matching lookup in order to locate output port information from a routing table. The longest prefix matching is a method for selecting, as routing information of the received packet, an entry with the longest prefix from all entries whose prefix portions of the network address match the destination address through a lookup process in comparing the destination IP address of the received packet with all entries of the routing table.

Once the routing system succeeds in its IP address lookup, it sequentially reduces a Time to Live (TTL) value of the IP header and calculates a new header checksum, correcting the header. Then, the system transfers the packet to an output port via a backplane, attaches a link layer header to the packet at the output line card, and transfers the packet to the next routing system (or a destination host). If such a procedure fails to succeed, the system indicates the failure in routing through the transfer of an Internet Control Message Protocol (ICMP) error message to a native place host of the packet.

Much research has been performed in order to improve a performance of the routing system, and other research has also been performed on an IP address lookup process that is one of the targets for high speed in the course of IP forwarding. The representative methods include a Trie based method, a hasing based method, a binary search based method, and a hardware based method.

The Trie based method is a method that compresses an original Trie with a level per one bit into a Trie with a level per multi-bit to reduce the number of the levels, i.e., the access number to memory. In the Trie, the number of levels in the longest route is the maximum access number to memory.

The binary search based method is used for exact matching, in which a sorted array formed with a partial transform of the prefix is used for the Longest Prefix Matching (LPM). Among the hardware-based methods, a method using a Content-Addressable Memory (CAM) is representative. This method, however, has drawbacks in that the processing thereof is expensive even through it is the fastest method, and the number of routing entries is below a few K.

A Patricia-Trie is also used to efficiently implement a forwarding in the case of an addition or deletion of a route. Upon the restart of the routing performance module, such as an Open Shortest Path First (OSPF) or a Border Gateway Protocol (BGP), the routing entries updated in the restarted routing performance module among entries in the routing table are checked as to whether or not the contents thereof are available. At this time, a protocol, such as OSPF or BGP, recognizes all route entries as being available for a specified period to support a graceful-restart. Route information is received from other external routing systems so that only the updated route entries are used. Herein, the graceful-restart is a function of minimizing an affect of the restarting routing module. If there is no graceful-restart, upon the restart of the routing module, undesirable network operation might be caused due to route recalculation and wide route update.

In Trie based routing management, if n pieces of route information existed before, it needs a time (log n) for seeking route information being updated by OSPF or BGP. This is the case with an addition or deletion of a route, and the existence of many entries by the corresponding protocol results in deteriorating system performance.

### SUMMARY OF THE INVENTION

It is, therefore, an object of the present invention to provide a routing system and a route update method which first perform a search according to an insertion sequence by each routing protocol before a Trie search, and if the search according to the insertion sequence fails, perform the existing Trie search.

To achieve the above and other objects, in accordance with one aspect of the present invention, a method of updating a routing table with a Trie structure is provided, the method including: storing information on a route insertion sequence by each routing protocol in respective entries in the routing table; performing a prefix search according to the stored route insertion sequence upon a restart of a routing module; and updating a corresponding routing entry upon a prefix matching occurring as a result of the prefix search.

The method preferably further includes performing a search according to the Trie structure upon a prefix matching failure to succeed occurring as a result of the prefix search.

The routing protocols preferably include at least one of a Routing Information Protocol (RIP), an Open Shortest Path First (OSPF) protocol, and a Border Gateway Protocol (BGP).

The respective entries in the routing table preferably include connection information with entries before and after the corresponding insertion sequence by each protocol. The connection information is preferably expressed in the form of a double linked list.

The Trie structure is preferably one of a binary Trie, a Patricia Trie, a path compressed Trie, a multi-bit Trie, and an LC-Trie.

To achieve the above and other objects, in accordance with another aspect of the present invention, a method of updating a routing table with a Trie structure is provided, the method including: storing information on a route insertion sequence by each routing protocol in respective entries in the routing table; performing a prefix search according to the stored route insertion sequence upon a restart of a routing module; and updating a corresponding routing entry upon a prefix matching occurring as a result of the prefix search, and performing a search according to the Trie structure upon a prefix matching failure to succeed occurring.

Respective entries in the routing table preferably include connection information with entries before and after the corresponding insertion sequence by each protocol.

To achieve the above and other objects, in accordance with yet another aspect of the present invention, a routing system is provided including: a routing table adapted to store information on a route insertion sequence by each protocol in a Trie structure for each entry; and a routing module adapted to perform a prefix search according to the stored route insertion sequence upon a restart thereof, and updating a corresponding routing entry upon a prefix matching occurring as a result of the prefix search.

The routing module preferably includes: a Routing Information Protocol (RIP) routing module adapted to perform an update for respective entries in the routing table according to the RIP; an Open Shortest Path First (OSPF) routing module adapted to perform an update for the respective entries in the routing table according to an OSPF protocol; and a Border Gateway Protocol (BGP) routing module adapted to perform an update for the respective entries in the routing table according to the BGP.

The routing module preferably performs a search according to the Trie structure upon a prefix matching failure to succeed occurring as a result of the prefix search.

The routing table preferably includes at least one entry having connection information with entries before and after the corresponding insertion sequence by each routing protocol. The connection information is preferably expressed in the form of a double linked list.

The Trie structure is preferably one of a binary Trie, a Patricia Trie, a path compressed Trie, a multi-bit Trie, and an LC-Trie.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of a Patricia Trie structure for the update of an Internet protocol (IP) routing table to which an embodiment of the present invention is applied;

FIGS. 2A-2D are views of various Trie structures for the update of an IP routing table to which an embodiment of the present invention is applied;

FIG. 3 is a block diagram of a routing system according to an embodiment of the present invention; and

FIG. 4 is a view of a routing Trie structure according to an embodiment of the present invention.

### DETAILED DESCRIPTION OF THE INVENTION

Hereinafter, exemplary embodiments of the present invention are described in detail with reference to the accompanying drawings.

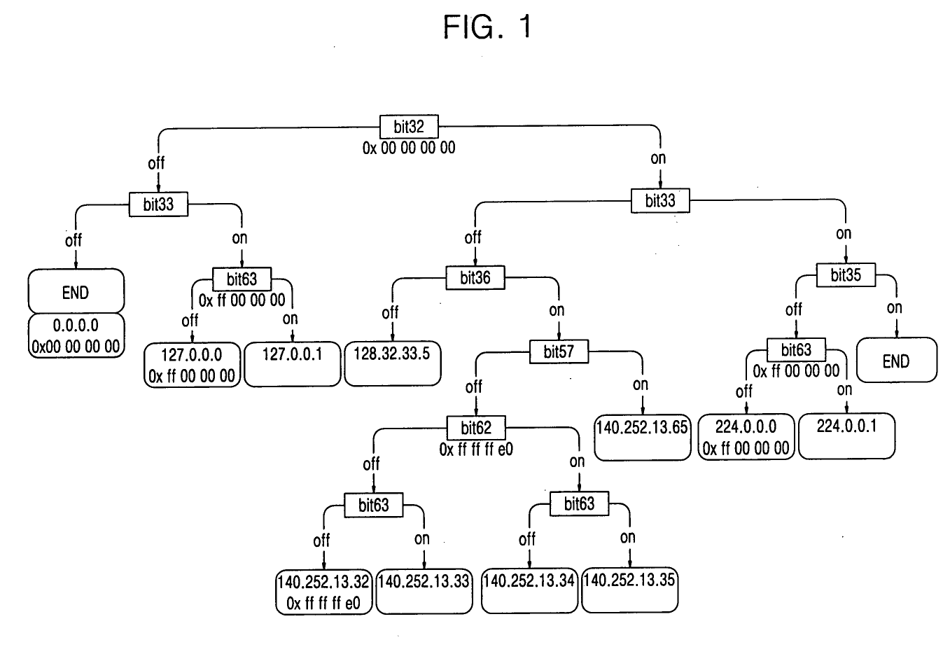

FIG. 1 is a view of a Patricia Trie structure for the update of an Internet protocol (IP) routing table to which an embodiment of the present invention is applied.

The Patricia-Trie as illustrated in FIG. 1 is a representative algorithm based on a Trie. The Patricia-Trie is a method that is used in a Berkeley Software Distribution (BSD) based UNIX and many existing routing systems. The Patricia-Trie makes a routing table have a tree structure so that a path from a root to a leaf of the tree becomes a routing entry. Herein, a process for finding a longest path matching a destination IP address of a packet is a Longest Prefix Matching (LPM). The Patricia-Trie considerably reduces the use of memory whereas IPv4 needs a maximum of 32 times memory access, and IPv6 needs a maximum of 128 times memory access.

FIG. 1 shows a procedure of a routing table for the lookup of the packets whose IP addresses correspond to bit 32 to bit 63 using the Patricia Trie structure, and wherein the rectangular forms denote an internal node, and round rectangular forms denote a leaf node. The lookup process is performed to compare bit 32 of the input packet with others of the Patricia Trie structure sequentially from the most significant object thereof to the leaf nodes such that a value of the leaf node and an IP address of the received packet are compared and, if they match with each other, a network interface where the IP packet is forwarded can be found using the corresponding node.

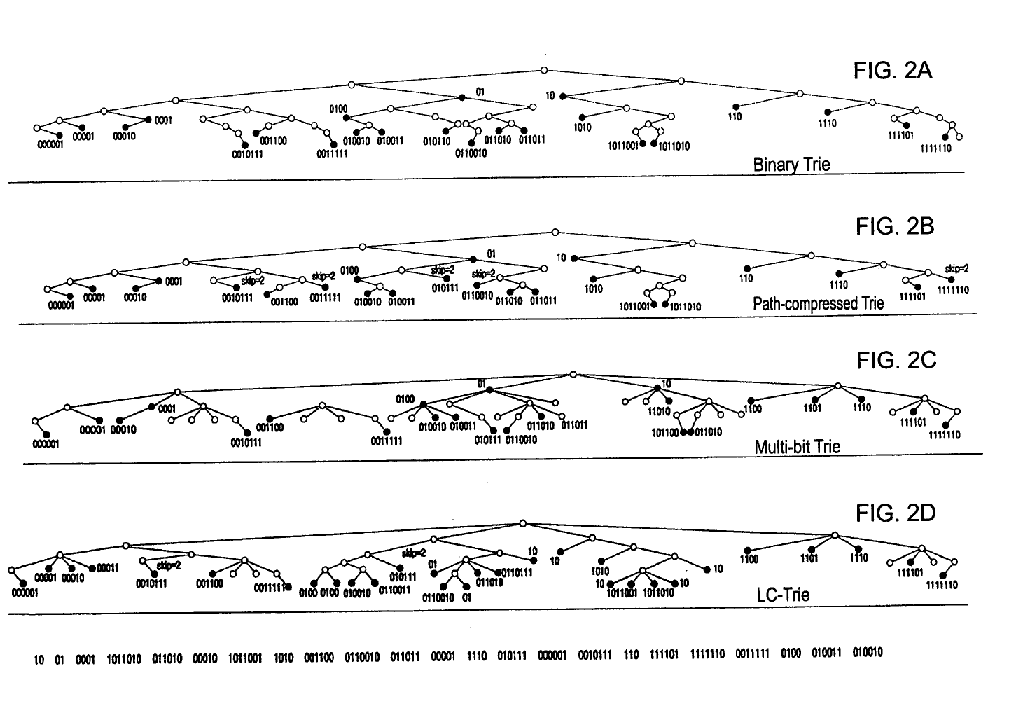

FIGS. 2A-2D are views of various Trie structures for the update of an IP routing table to which an embodiment of the present invention is applied.

The respective Tries in FIGS. 2A-2D are structured by using the same sample prefix.

FIG. 2A shows a binary Trie structure for storing a prefix in a node of the Trie. In this case, O(W) times of memory access is required. FIG. 2B shows a path compressed Trie structure for compressing a node that has a child while being an empty node to reduce the maximum access times to the memory. FIG. 2C shows “a multi-bit Trie structure for increasing the number of children that one node can hold to reduce the access times to the memory. In this method, in case of K-bit Trie, the access time is reduced to O(W/K), but a storing method of the Trie becomes disadvantageously complicated. In case of a level compressed (LC)-Trie of FIG. 2D, in spite of having more compact construction than the existing Trie, it still needs a maximum O(W/K) access times to the memory.

As seen from FIGS. 1 and 2A-2D, according to the general Trie based algorithm, an original Trie with one level by one bit is compressed to one with one level by multi-bit to reduce the number of levels, i.e., the maximum access times to the memory. In the Trie structure, the level number of the longest path becomes the maximum access times to the memory.

Such Trie structure is applied to the routing lookup as well as to the update process of the route entries with the same principle.

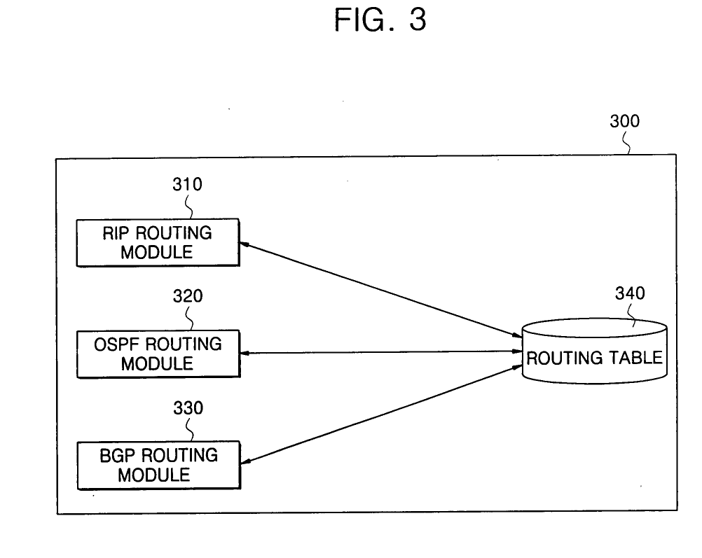

FIG. 3 is a block diagram of a routing system according to an embodiment of the present invention.

The routing system of the present invention includes a Routing Information Protocol (RIP) routing module 310, an Open Shortest Path First (OSPF) routing module 320, a Border Gateway Protocol (BGP) routing module 330, and a routing table 340.

The RIP routing module 310 performs an RIP routing with reference to the routing table 340. The RIP is a protocol that is broadly used for the routing information management in an independent network, such as a Local Area Network (LAN), in company or a group formed with the connection of such LANs. With the use of the RIP, a gateway host in the routing system transfers all routing tables to the nearest adjacent host every 30 seconds. The adjacent host in turn transfers the information to the next host and the transfer is repeated until all hosts in the network have the same routing path information. The RIP uses the total sum of hops in order to determine a network distance (whereas other protocols use a more precise algorithm including even timing). The respective hosts having a routing system in the network use routing table information to determine the next host where they transfer the packet. Although the RIP is considered as an effective solution in a small scale and same type of network, in a more complicated large scale network, the RIP causes a problem of burdening the network with a great amount of additional load due to the transfer every 30 seconds of all routing tables.

The OSPF routing module 320 is a block to perform the routing according to the OSPF routing protocol with reference to the routing table.

The general operation of the OSPF protocol is as follows.

In the mid-1980s, when the RIP had reached the limits of the performance of the routing between the large scale and different type networks, an Internet Engineering Task Force (IETF) had developed an IP network routing algorithm for adapting to Internet based on a Shortest Path First (SPF) algorithm with the result that the OSPF had been created.

With the use of OSPF, the host that has detected the change of the routing table or any change in the network immediately informs all other hosts in the network of the information so that all hosts can have the same routing information. Unlike the RIP transferring all the routing tables, the host using OSPF transfers only those changed portions. While the RIP transfers the routing table to the adjacent host every 30 seconds, the OSPF multi-casts the changed information only when a change occurs.

The OSPF is based on the path class of the link status referring to additional network information rather than simply counting the number of hops. Also, the OSPF allows the user to set a specified host router so as to offer a priority for some paths according to his/her preference. The OSPF supports various network subnet masks in order for one network to be in turn subdivided. The RIP is supported for communication between a router and an end station in the OSPF. Since many networks have already used the RIP, the router manufacturers are likely to include the support of RIP in the router originally designed for OSPF.

The OSPF opens all specifications to the letter and those specifications have been announced in RFC 1247 (which has been now replaced with RFC 1583; OSPF Version 2).

Unlike the RIP, the OSPF has layers for adapting a routing algorithm. In the layers, there is an Autonomous System (AS) as the largest layer, which system is defined as the network integration managed by one management system and sharing with a common routing strategy. One AS is in turn divided into several areas (AREA), which is expressed as the integration of a continuous network and the access systems. A network to connect the areas in one AS is called a backbone network and a kind of routers is classified according to such layers, the router including an internal router, an area border router, a backbone router, an AS boundary router and others.

The internal router is a router directly accessing a network which belongs to one area and includes even a router accessing a backbone network. The area border router is a router for connection between an area and a backbone network. The area border router transfers the sum-up of path information on an accessed area to the backbone network through which the information is distributed to other area border routers (FIG. 1: routers 4, 10, 11, and 12).

The backbone router is all routers accessing the backbone network and includes an area border router and an internal router belonging to a backbone network. The AS boundary router is a router exchanging path information with a router belonging to other AS, this path information being transferred to all AS′ as an AS external path. The path for the AS boundary router is known to all routers belonging to AS.

The OSPF router can perceive the adjacent router each other by exchanging the Hello packets each other upon the initial booting. Then, it designates a representative router responsible for the creation and distribution of path information on the network, among the plurality of routers accessing the specified network. The representative router exchanges path information with the newly perceived router to synchronize. The OSPF router transfers information on its path table periodically or at the time when a state of router changes, through a data architecture of Link State Advertisement (LSA), so that the LSA is known to all routers in the corresponding area. All routers belonging to one area thus share the same information.

Information sharing between areas is performed as follows: Since the area border router is connected to the backbone network of AS, it can obtain information on other areas and a topology of AS through exchange of summary information on the area with other area border routers. The paths for all destinations that do not belong to its own area can thus be calculated, and the calculated paths are transferred to the internal router. The internal router can determine on to which area border router it transfers the packet when transferring to a destination that belongs to another area.

Since the AS boundary router knowing external path information for other AS can transfer information via the AS, external path information is transferred in the form of area summary information to the internal router by the boundary routers in all areas excluding a stub area. Accordingly, a position of the AS boundary router connecting with other AS is known to all routers other than the router belonging to the stub area so that information can be transferred to the exterior of the AS.

In such way, the OSPF router gains information on the paths of the area interior, the area exterior, and the AS exterior to construct topology database. The OSPF router performs the packet relay with the application of the SPF algorithm to the topology database to calculate a shortest path tree from itself for all paths and to maintain it on the path table.

The BGP routing module 330 is a module for performing the routing according to a BGP protocol that is a routing protocol between domains.

The operation mode of the BGP is as follows:

First, for communication between BGP routers belonging to different AS′ (management domain), they should be directly connected in a single network without the relay by other networks, and if the plurality of BGP routers exist in one AS, the BGP routers should have consistent information on the AS and perceive each other and exchange information with each other in order to perform a function as an external path of the AS.

When the BGP router is connected with another, it exchanges all its contents of the path table, initially, and only those of changed portions, later, with each other. At this time, although the BGP router holds all suitable paths for a specified destination, it transfers only an optimum path to the path update message. Such an information exchange is reliably performed by a Transmission Control Protocol (TCP).

Although the BGP is a routing algorithm based on the same distance vector as the RIP, it does not transfer a value of path-to-destination, but transfers the routing sequence of AS′ to the destination, so that it does not have a problem of counting to infinity that the distance vector algorithm has.

Upon the restart, the RIP routing module 310, the OSPF routing module 320, and the BGP routing module 330 check the effectiveness for the entries updated by the corresponding protocols, among the entries in the routing table. Upon the restart, the routing modules, however, use only route entries received from other external router and updated after admitting all routing entries as an effective route entry for some period in order to support the graceful-restart. Accordingly, due to the graceful-restart function, there is every probability that the route entries received from the exterior would match with the insertion sequence of the existing route entries.

Thus, the routing modules of this embodiment of the present invention, i.e., the RIP routing module 310, the OSPF routing module 320, and the BGP routing module 330, store the insertion sequence of the route entries by each protocol before performing the binary search, and upon restart of the protocol thereafter, first perform comparison between the previously inserted route entry and the next time-inserted route entry before performing the binary search, and if the two entries are same, do not perform the binary search.

To this end, the respective routing entries of the routing table 340 include information on the sequence that the routing entries are inserted for each routing protocol. Then, they form the connection relationship with the previously inserted route entries using a double linked list.

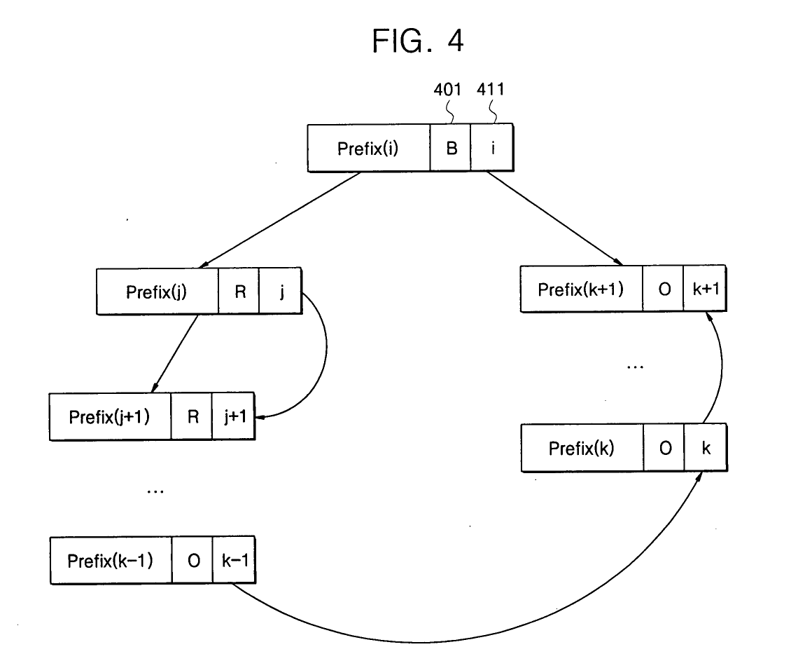

FIG. 4 is a view of a routing Trie structure according to an embodiment of the present invention.

As illustrated in FIG. 4, the routing table stores information 411 on the routing entry insertion sequence by each protocol 401, in addition to information of the existing routing table. That is, it can be seen that the routing entry for the prefix i positioned at the top level of the Trie structure of FIG. 4 is an entry inserted by the BGP protocol and the insertion sequence by the BGP protocol is i-th ranked. The Trie structure of FIG. 4 can be the most common binary Trie, or can otherwise be a Patricia Trie, a path compressed Trie, a multi-bit Trie, an LC-Trie, etc.

Accordingly, if the prefix (k-1) is a route entry (k-1)-th updated by the OSPF routing module, when a routing entry by the next OSPF protocol is added, a search is first performed using route entry position information for the prefix (k), instead of using the Trie search (the binary search or the modified search thereof) and others.

If the route entry search using the insertion sequence fails to succeed, the search is performed using the Trie search of the existing method. In this case, the search time increases by one, so that if the average comparison time when not using insertion sequence information is t, the comparison time when using insertion sequence information is t+1. However, considering the case where the entry search using insertion sequence information succeeds, the statistical comparison time would be of much less value than t.

According to the present invention, an insertion sequence of a new route entry is previously stored for each routing protocol, and upon restart of a routing module, the routing entry is updated using the stored sequence, thereby reducing a routing search time.

While the present invention has been described in conjunction with various embodiments, the present invention is not limited thereto and accordingly, many alternatives, modifications and variations will be apparent to persons skilled in the art in light of the foregoing detailed description. The foregoing description is intended to embrace all such alternatives and variations falling with the spirit and broad scope of the appended claims.

What is claimed is:

1. A method of updating a routing table with a Trie structure, the method comprising:
storing information on a route insertion sequence by each routing protocol in respective entries in the routing table;
performing a prefix search according to the stored route insertion sequence upon a restart of a routing module; and
updating a corresponding routing entry upon a prefix matching occurring as a result of the prefix search.

2. The method according to claim 1, further comprising performing a search according to the Trie structure upon a prefix matching failure to succeed occurring as a result of the prefix search.

3. The method according to claim 1, wherein the routing protocols include at least one of a Routing Information Protocol (RIP), an Open Shortest Path First (OSPF) protocol, and a Border Gateway Protocol (BGP).

4. The method according to claim 1, wherein the respective entries in the routing table include connection information with entries before and after the corresponding insertion sequence by each protocol.

5. The method according to claim 4, wherein the connection information is expressed in the form of a double linked list.

6. The method according to claim 1, wherein the Trie structure is one of a binary Trie, a Patricia Trie, a path compressed Trie, a multi-bit Trie, and an LC-Trie.

7. A method of updating a routing table with a Trie structure, the method comprising:
storing information on a route insertion sequence by each routing protocol in respective entries in the routing table;
performing a prefix search according to the stored route insertion sequence upon a restart of a routing module; and
updating a corresponding routing entry upon a prefix matching occurring as a result of the prefix search, and performing a search according to the Trie structure upon a prefix matching failure to succeed occurring.

8. The method according to claim 7, wherein respective entries in the routing table include connection information with entries before and after the corresponding insertion sequence by each protocol.

9. A routing system, comprising:
a routing table adapted to store information on a route insertion sequence by each protocol in a Trie structure for each entry; and
a routing module adapted to perform a prefix search according to the stored route insertion sequence upon a restart thereof, and updating a corresponding routing entry upon a prefix matching occurring as a result of the prefix search.

10. The system according to claim 9, wherein the routing module comprises:
a Routing Information Protocol (RIP) routing module adapted to perform an update for respective entries in the routing table according to the RIP;
an Open Shortest Path First (OSPF) routing module adapted to perform an update for the respective entries in the routing table according to an OSPF protocol; and
a Border Gateway Protocol (BGP) routing module adapted to perform an update for the respective entries in the routing table according to the BGP.

11. The system according to claim 9, wherein the routing module performs a search according to the Trie structure upon a prefix matching failure to succeed occurring as a result of the prefix search.

12. The system according to claim 9, wherein the routing table includes at least one entry having connection information with entries before and after the corresponding insertion sequence by each routing protocol.

13. The system according to claim 12, wherein the connection information is expressed in the form of a double linked list.

14. The system according to claim 9, wherein the Trie structure is one of a binary Trie, a Patricia Trie, a path compressed Trie, a multi-bit Trie, and an LC-Trie.
